(19) United States
(12) Patent Application Publication
(10) Pub. No.: US 2007/0260900 A1
(43) Pub. Date: Nov. 8, 2007

(54) High-performance microprocessor with lower-performance microcontroller in a vehicle network

(75) Inventors: Cong Nguyen, Cupertino, CA (US); Volker Hans Joachim Politz, Livonia, MI (US)

Correspondence Address: THELEN REID BROWN RAYSMAN & STEINER LLP, 2225 EAST BAYSHORE ROAD, SUITE 210, PALO ALTO, CA, 94303, US

(73) Assignee: Renesas Technology America, Inc.

(21) Appl. No.: 11/417,433

(22) Filed: May 3, 2006

(51) Int. Cl. G06F 1/00

(52) U.S. Cl. 713/300

(57) ABSTRACT

A system comprises an integrated package including a microcontroller having a vehicle bus controller, e.g., a CAN controller, for communicating directly with a vehicle bus, the microcontroller being always active; and a microprocessor having a communication module for communicating with the microcontroller, and not having a vehicle bus controller for communicating directly with the vehicle bus. The system may further include a power switch circuit for enabling the microcontroller to control power to and the state of the microprocessor. The microcontroller and the microprocessor may intercommunicate via a dedicated channel. The microcontroller may also have a hard-coded sequencer for enabling the microcontroller to load microcontroller control code into internal RAM of the microcontroller, which it receives from the microprocessor.

### TECHNICAL FIELD

This invention relates generally to multiprocessor systems, and more particularly provides an integrated higher-performance microprocessor with a lower-performance microcontroller in a vehicle network.

### BACKGROUND

A vehicle bus is an electronic communications network that interconnects components inside an automobile, bus, industrial or agricultural vehicle, ship, or aircraft. Due to the specialized requirements of each type of deployment (including environmental constraints, cost, reliability and real-time characteristics), conventional computer networking technologies such as Ethernet and TCP/IP are rarely used.

Some main motivations for the development of vehicle network technology have been the advances made in the electronics industry and government regulations imposed, especially in the United States, to make the automobiles environmentally friendly. With stringent limitations placed on the emission gases for automobiles, it became impossible to attain a compliant level of control without the help of on-board computing devices. On-board electronic devices have also contributed substantially to vehicle performance, occupant comfort, ease of manufacture and cost effectiveness.

At one time, a radio was likely the only electronic device in an automobile. But now, almost every component of the vehicle has some electronic feature. Typical vehicle electronic components on the vehicle bus include engine control modules, transmission control modules, anti-lock brake system modules, the timing control module, body control modules, telephone control units, door control units, seat control units, climate control units, etc. An electronic control module typically gets its input from sensors (speed, temperature, pressure, etc.) that it uses in its computations. Various actuators are used to enforce the actions determined by the module (turn the cooling fan on, change gear, etc.). Some modern cars have up to seventy electronic control modules.

The electronic control modules need to exchange data among themselves during the normal operation of the vehicle. For example, the engine needs to tell the transmission what the engine speed is, and the transmission needs to tell other modules when a gear shift occurs. This need to exchange data quickly and reliably led to the development of the vehicle network.

When developing the vehicle network, the automotive industry realized the complexity of wiring each module to every other module. The industry's answer to this problem was to create a central network in the vehicle. FIG. 1 illustrates an overview of this design. As shown, the vehicle network system 100 includes various electronic control modules 105-125, each coupled to the vehicle network 130. Modules can be plugged into the network and can communicate with any other installed module. This design is easy to manufacture, easy to maintain and provides the flexibility to add and remove options without affecting the entire vehicle's wiring architecture. Each node on the vehicle network controls specific components related to its function and communicates with the other modules as necessary, using a standard protocol, over the vehicle network.

These vehicle networks called for low cost, immunity from external noise, the ability to operate in harsh environments, and an overall robustness and reliability. Although the vehicle network did not place too much emphasis on the data throughput, the demand for more on-board computing is continuing to drive changes to these networks to provide higher-speed communication between modules.

There are several network types and protocols used in vehicles by various manufactures. Many companies are encouraging a standard communication protocol, but one has not been settled on. Some examples of transmission media use in vehicle networks single wire, twisted pair, optic fiber, and power line communication.

Common vehicle busses include:
Local Interconnect Network (LIN)—a very low cost in-vehicle sub-network
Controller Area Network (CAN)—an inexpensive low-speed serial bus for interconnecting automotive components
J1939 and ISO11783—an adaptation of CAN for agricultural and commercial vehicles
FlexRay—a general purpose high speed protocol with safety-critical features
Media Oriented Systems Transport (MOST)—a high speed multimedia interface
Keyword Protocol 2000 (KWP2000)—a protocol for automotive diagnostic devices (runs either on a serial line or over CAN)
Vehicle Area Network (VAN)
DC-BUS [5]—Automotive power-line communication multiplexed network
IEBUS—a vehicle bus with CSMA/CD for access control
Proprietary vehicle bus standards—often overlayed over open protocols such as CAN

As higher-speed microprocessors are being added to the vehicle network, power consumption is becoming a concern. Since vehicle power often relies solely on battery power, a balance must be met between implementing higher-speed microprocessors (which consume more power but manage computationally intensive tasks) and smaller microprocessors, e.g., microcontrollers, (which consume less power but do not manage computationally intensive tasks as well) on the vehicle network.

Car manufacturers are demanding the following characteristics from in-vehicle systems such as telematics or CIS: (1) low power consumption, (2) a response time of in-vehicle messages among system nodes in the range of milliseconds even while systems are powered off or under standby mode, and (3) higher performance processors year after year. Regarding response time, often, there is a relatively large-footprint operating system (OS) running on the vehicle platforms. This operating system usually takes a long time, e.g. 100 ms, to start up from power up or from standby wake-up, which may be critical in total in-vehicle message response time. Before in-vehicle messages can be sent or received, startup time normally involves hardware PLL startup, RAM initialization, memory management unit initialization, and other control units initialization.

To address power consumption, response time and performance concerns in today's in-vehicle systems, system integrators are using a smaller microcontroller module. A higher speed microprocessor handles computationally intensive tasks and is responsible for operating system startup from initial power up and from standby modes. A lower speed microcontroller remains responsible for handling simple tasks while the microprocessor launches the operating system.

FIG. 2 illustrates a prior art vehicle CAN network system 200. Vehicle CAN network system 200 includes a discrete microcontroller device 205 coupled to a vehicle CAN network 240. The microcontroller device 205 may be referred to as CPU_A. The microcontroller device 205 includes a CAN IP module for communicating with the vehicle CAN network 240, possibly using GM's GMLAN (OnStar) protocols, Daimler/Chrysler's DCNET protocols, Ford's FNOS protocols, or the like. The vehicle CAN network system 200 also includes a discrete microprocessor device 210 coupled to the microcontroller device 205 or coupled to the vehicle CAN network 240 directly. The microprocessor device 210 may be referred to as CPU_B.

To establish a connection between the microcontroller device 205 and the microprocessor device 210, each device may have an RSPI or UART module, namely, an RSPI or UART device 225 in microcontroller device 205 and an RSPI or UART device 245 in microprocessor device 210, for communicating therebetween. SPI is the Motorola serial peripheral interface for data communication. It is often used in automotive electronics. RSPI is an SPI interface designed by Renesas Corporation, which is compatible with the Motorola SPI.

To establish a direct connection with the vehicle CAN network 240, the microprocessor device 210 has a CAN IP module 295 (similar to the CAN IP module 215 of the microcontroller device 205). The microprocessor device 210 has to instruct its CAN module for every command it needs to communicate to the CAN network. The response is slow at startup since the microprocessor device 210 has to initialize itself and other key modules such as RAM, ROM, DMAC, INTR, MMU, CACHE, etc. before accessing the CAN vehicle network 240 can be possible. The microprocessor device 210 may include a real time clock (RTC) 255 with an RTC voltage source (VDD) 265 and ground 270, and bus control logic 260 for controlling memory devices such as ROM/Flash 275 and RAM 280.

In a typical implementation, the microcontroller device 205 is a low-to-medium speed processor, is capable of power moding, has internal ROM storing the microprocessor control code, has RAM, and has other IPs to handle timers, interrupts, GPIO, etc. The microprocessor device 210 is a high-speed processor with caching, an FPU and an MMU, has other IPs to handle timers, GPIO, etc., and has multimedia IPs to handle audio, displays, ATAPI, USB, etc. The microcontroller device 205 has a VDD 230 connected to an always-on voltage source (“VDD-always-on”) and a VSS 235 connected to ground. The microprocessor device 210 is connected to a switched voltage source (“Switched-VDD”) 285 and ground 290. The microcontroller device 205 handles only minor tasks and those tasks necessary while the microprocessor device 210 is powered down. Example tasks for the microcontroller device 205 include responding to incoming CAN messages at initial power on/reset and after waking up from standby mode, transferring messages from the microprocessor device 210 to the vehicle CAN network 240 (when connected in series), responding to low-level CAN protocol requests, screening incoming CAN messages, and relaying messages intended for the microprocessor device 210. The microprocessor device 210 handles power-up, monitors system resources when powered up, and shuts down. To determine when its services are needed, the microprocessor device 210 may power itself up periodically, e.g., every hour, to determine if there are any messages waiting, e.g., any requests to unlock the doors by the OnStar service.

Because each of the microcontroller device 205 and the microprocessor device 210 may be coupled to the vehicle CAN network 240 directly, manufacturers must obtain GM authorization for each device 205 and 210 independently to be identified as OnStar-compliant, thereby adding to the cost of the components.

### SUMMARY

In a first embodiment, the present invention provides a system comprising an integrated package including a microcontroller having a vehicle bus controller for communicating directly with a vehicle bus, the microcontroller being always active; and a microprocessor having a communication module for communicating with the microcontroller, and not having a vehicle bus controller for communicating directly with the vehicle bus. The vehicle bus controller may be a CAN controller. The system may further include a power switch circuit for enabling the microcontroller to control power to the microprocessor. The power switch circuit may control the state of the microprocessor. The microcontroller and the microprocessor may intercommunicate via a dedicated channel.

In another embodiment, the present invention provides a system comprising an integrated package including a microcontroller having a vehicle bus controller for communicating directly with a vehicle bus, having internal RAM, and having a hard-coded sequencer for enabling the microcontroller to load microcontroller control code into the internal RAM, the microcontroller being always active; and a microprocessor having a communications module for communicating with the microcontroller, and having access to microcontroller control code for the microcontroller, the microprocessor being configured to forward the microcontroller control code to the microcontroller, the microprocessor being faster than the microcontroller.

In yet another embodiment, the present invention provides a method comprising determining that microcontroller control code is not loaded on a microcontroller, the microcontroller being connectable to a vehicle network; obtaining microcontroller control code from first external memory by a microprocessor, the microprocessor being faster than the microcontroller and being communicatively coupled to the microcontroller, the microcontroller and microprocessor being integrated in the same package; transferring the microcontroller control code from the first external memory to the microcontroller; and loading the microcontroller control code into internal RAM on the microcontroller.

The method may also include determining that microprocessor control code is not loaded into the microprocessor, obtaining microprocessor control code from second external memory, and loading the microprocessor control code into internal RAM on the microprocessor device. The first external memory and second external memory may be part of the same device. The microcontroller control code may be compliant with a vehicle bus standard, e.g., GM's GMLAN (OnStar) standard, Daimler/Chrysler's DCNET standard, Ford's FNOS standard, or the like. The first external memory may also serve another package including a microcontroller and microprocessor pair. That way, only one memory need obtain compliance certification. The method may also include using pin strapping settings to select the microcontroller control code from a set of various microcontroller control code options.

### BRIEF DESCRIPTION OF THE DRAWINGS

FIG. 1 is a block diagram illustrating a first prior art vehicle network system.

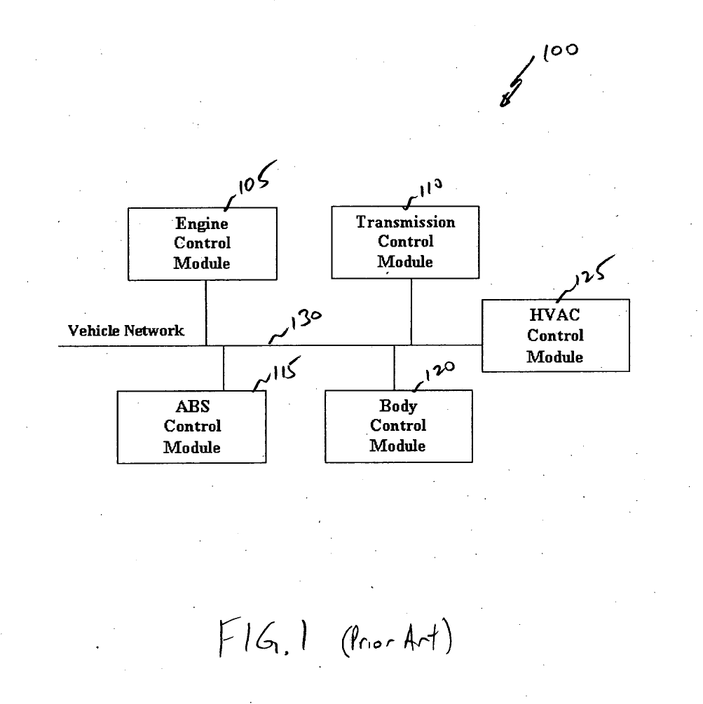

FIG. 2 is a block diagram illustrating a second prior art vehicle network system.

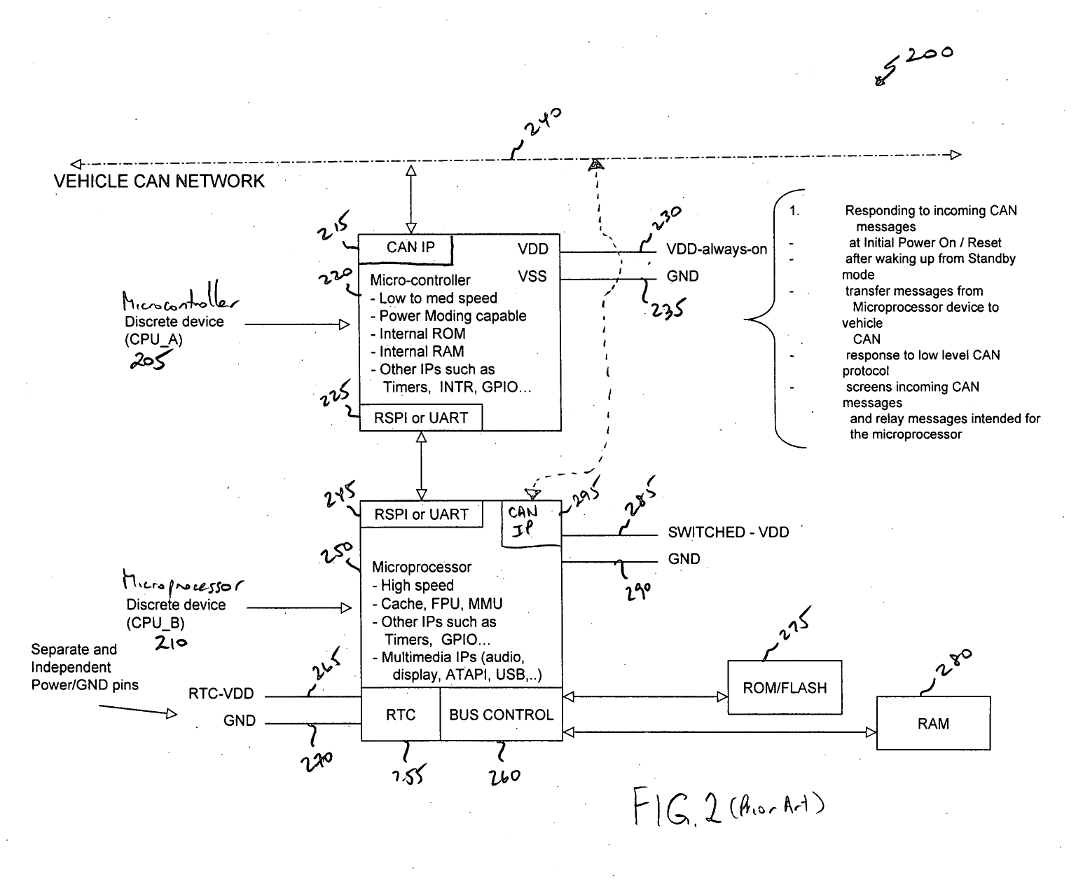

FIG. 3 is a block diagram of a vehicle CAN network system using an integrated package, in accordance with an embodiment of the present invention.

FIG. 4 is a block diagram of a vehicle CAN network system using an integrated package and a power switch circuit, in accordance with an embodiment of the present invention.

FIG. 5 is a block diagram of a vehicle CAN network system using an integrated package, no internal ROM in the microcontroller, and user interrupt circuitry, in accordance with an embodiment of the present invention.

FIG. 6 is a block diagram illustrating an example integrated package, in accordance with an embodiment of the present invention.

FIG. 7 is a flowchart illustrating a method of loading microcontroller control code onto a microcontroller and microprocessor control code onto a microprocessor, in accordance with an embodiment of the present invention.

FIG. 8 is a block diagram illustrating a vehicle CAN network system using initial mode setting pins, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

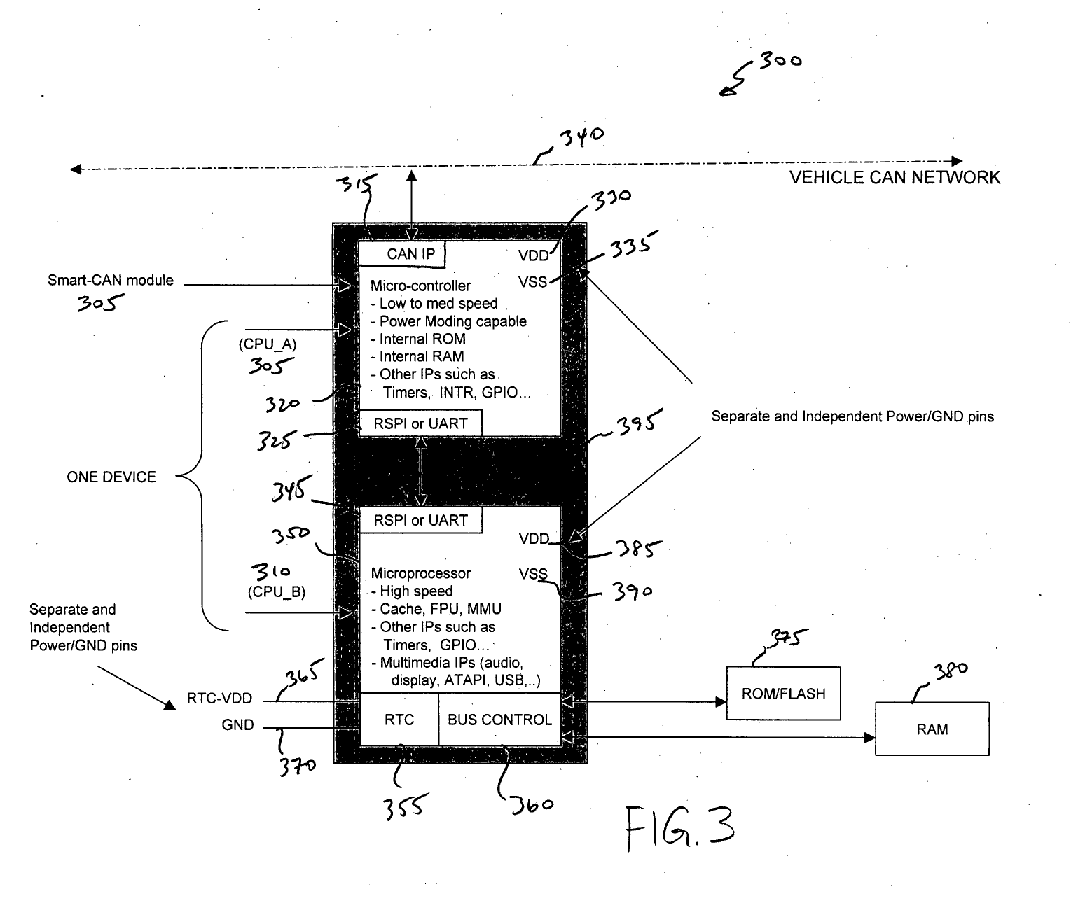

FIG. 3 is a block diagram of vehicle CAN network system 300, in accordance with an embodiment of the present invention. Vehicle CAN network system 300 includes a microcontroller device 305 (referred to as CPU_A) and a microprocessor device 310 (referred to as CPU_B), integrated together into a single package 395. The microcontroller device 305 is coupled to a vehicle CAN network 340. The microcontroller device 305 includes a CAN IP module 315 for communicating with the vehicle CAN network 340, possibly using GM's GMLAN (OnStar) protocols, Daimler/Chrysler's DCNET protocols, Ford's FNOS protocols, or the like. In this embodiment, the microprocessor device 310 does not include a CAN IP module, and therefore cannot connect to the vehicle network 340 directly.

To establish a connection between the microcontroller device 305 and the microprocessor device 310, each device may have an RSPI or UART module, namely, an RSPI or UART device 325 in microcontroller device 305 and an RSPI or UART device 345 in microprocessor device 310, for communicating therebetween. The microprocessor device 310 may include a real time clock (RTC) 355 with an RTC voltage source (VDD) 365 and VSS 370, and bus control logic 360 for controlling memory devices such as ROM/Flash 375 and RAM 380. The microcontroller device 305 may be capable of handling low-level tasks, may be capable of receiving messages intended for it and for the microprocessor device 310, and may know whether to respond on its own behalf, to respond on behalf of the microprocessor device 310, or to store and forward messages to the microprocessor device 310.

In this embodiment, the microcontroller device 305 is a low-to-medium speed processor, is capable of power moding, has internal ROM storing the microprocessor control code, has RAM, and has other IPs to handle timers, interrupts, GPIO, etc. The microprocessor device 310 is a higher-speed processor with caching, an FPU and an MMU, has other IPs to handle timers, GPIO, etc., and has multimedia IPs to handle audio, displays, ATAPI, USB, etc. The microcontroller device 305 has a VDD 330 connected to an always-on voltage source (“VDD-always-on”) and a VSS 335 connected to ground. The microprocessor device 310 has a VDD 385 connected to a separate and independent always-on voltage source (“VDD”) and a VSS 390 coupled to a separate and independent ground. Alternatively, the grounds may be coupled together.

The microcontroller device 305 handles minor tasks and those tasks necessary while the microprocessor device 310 is powered down. Example tasks for the microcontroller device 305 include responding to incoming CAN messages at initial power on/reset and after waking up from standby mode, transferring messages from the microprocessor device 310 to the vehicle CAN network 340, responding to low level CAN protocol requests, screening incoming CAN messages, and relaying messages intended for the microprocessor device 310. The microprocessor device 310 handles power-up, monitors system resources when powered up, and shuts down. To determine when its services are needed, the microprocessor device 310 may power itself up periodically, e.g., every hour, to determine if there are any messages waiting, e.g., any requests to unlock the doors by the OnStar service.

Example CPU_A has its own clock support circuitry so that it can start executing instructions without waiting for other devices clocking startup. CPU_A can handle fast startup from power up and standby, can respond to in-vehicle CAN messages while CPU_B is not in an active state such as powered down, standby mode, or while startup is in progress. CPU_A can relay CAN messages to CPU_B when CPU_B is operating in normal condition, has power moding capability in order to reduce power consumption, can control the power circuit for CPU_B portion, can communicate with CPU_B via serial communication interface such as RSPI, UART or via parallel interface such as static RAM interface or similar. CPU_A has internal RAM for executing code and data storage. This executing code can be downloaded from CPU_B using a built-in bootstrap program. Optionally, CPU_A has internal ROM to store already-CAN-compliant code. CPU_A can be integrated with many variations of CPU_B without affecting the CAN operation.

Example CPU_B has adequate power to handle normal operating conditions such as audio processing, multimedia processing, etc. CPU_B can download code and messages to CPU_A, can be powered down independently from CPU_A or other power control sources, and has power moding capability in order to reduce power consumption.

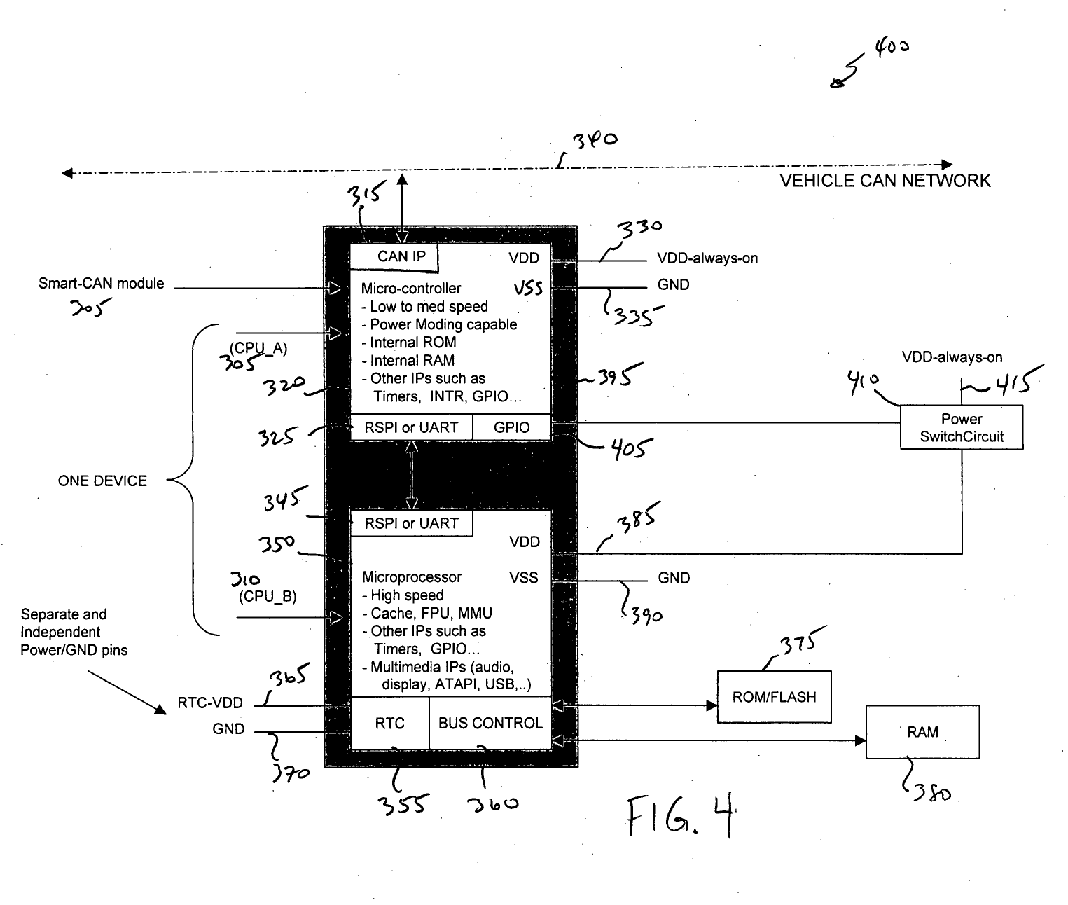

FIG. 4 is a block diagram of vehicle CAN network system 400, in accordance with an embodiment of the present invention. Vehicle CAN network system 400 includes modules and connections similar to those of FIG. 3. Thus, the modules and connections of FIG. 4 are labeled as elements 305-395, as in FIG. 3. For convenience, a discussion of the elements is not repeated. In contract to FIG. 3, FIG. 4 illustrates VSS 335 connected to ground and VSS 390 connected to ground, whether separate and independent or connected together. Microcontroller device 305 further includes a general purpose input output module (GPIO) 405. FIG. 4 further illustrates the vehicle CAN network system 400 further including a power switch circuit 410 that receives input from GPIO 405 and an always-on VDD 415 and that provides power output to VDD 385. Based on the signal from GPIO 405, the power switch circuit 410 powers up, powers down, places in standby mode or wakes up the microprocessor device 310. Accordingly, the microprocessor device 310 need not turn on periodically to find out if any messages are waiting for it. Instead, the microcontroller device 305, which is always on, can control the state of the microprocessor device 310 (e.g., turn it on only when its services are needed).

In this embodiment, the microcontroller device 305 is capable of responding to incoming CAN messages at initial power-on and reset and after waking up from standby mode. The microcontroller device 305 is capable of transferring messages from the microprocessor device 310 to the vehicle network 340, is capable of responding to low-level CAN protocol requests, is capable of screening incoming messages intended for the microprocessor device 310, and capable of powering the microprocessor device 310 at the time of CAN message reception. Further, the microcontroller device 305 may include any processes that a system integrator wishes to add, such as initializing the car's phone extensions when a registered Bluetooth-enabled phone is identified.

The microcontroller device 305 may have control code in its ROM for managing the various tasks. The control code will include the vehicle network compliant code. The microprocessor device 310 may store its control code in ROM/Flash 375. However, it's code need not be compliant code, since it need only speak with the microcontroller device 305, and not directly with the vehicle network 340.

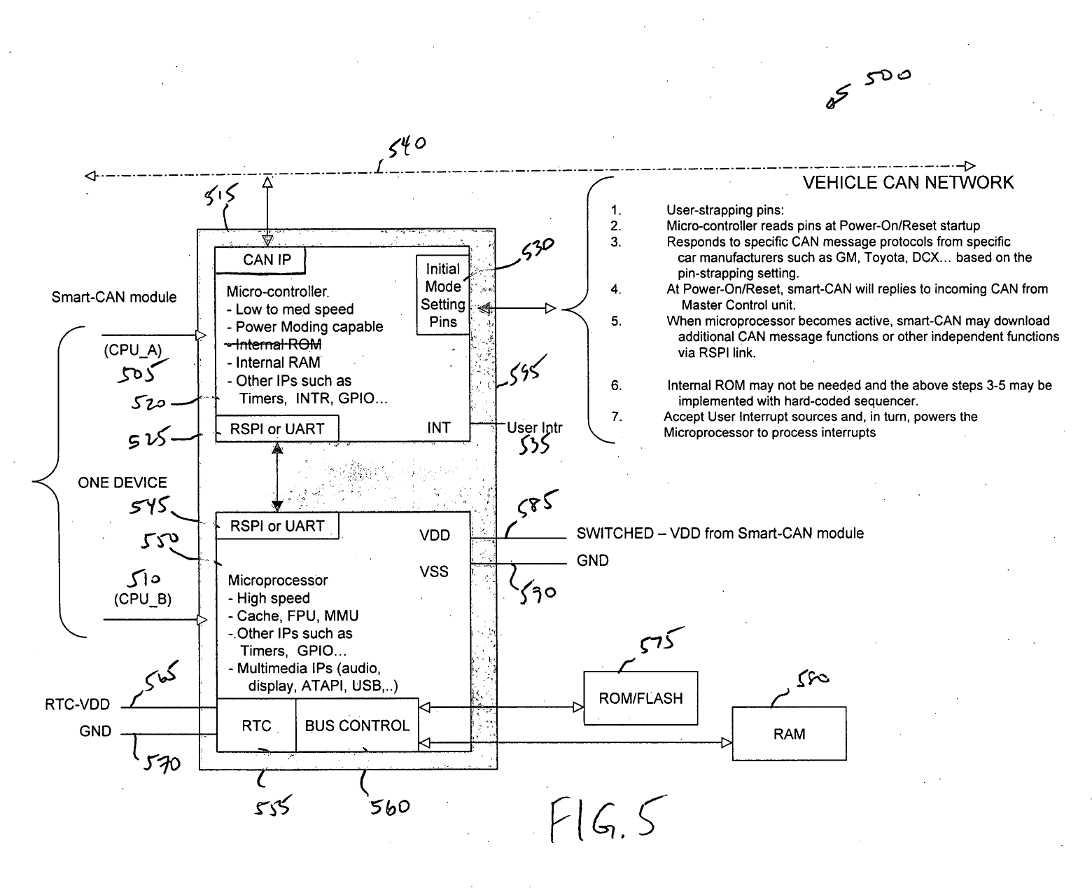

FIG. 5 is a block diagram of vehicle CAN network system 500, in accordance with an embodiment of the present invention. Vehicle CAN network system 500 includes a microcontroller device 505 (referred to as CPU_A) and a microprocessor device 510 (referred to as CPU_B), integrated together into a single package 595. The microcontroller device 505 is coupled to a vehicle CAN network 440. The microcontroller device 505 includes a CAN IP module 515 for communicating with the vehicle CAN network 540, possibly using GM's GMLAN (OnStar) protocols, Daimler/Chrysler's DCNET protocols, Ford's FNOS protocols, or the like. In this embodiment, like the system of FIG. 4, the microprocessor device 510 does not include a CAN IP module, and therefore cannot connect to the vehicle network 540 directly.

To establish a connection between the microcontroller device 505 and the microprocessor device 510, each device may have an RSPI or UART module, namely, an RSPI or UART device 525 in microcontroller device 505 and an RSPI or UART device 545 in microprocessor device 510, for communicating therebetween. The microprocessor device 510 may include a real time clock (RTC) 555 with an RTC voltage source (VDD) 565 and VSS 570, and bus control logic 560 for controlling memory devices such as ROM/Flash 575 and RAM 580. The microcontroller device 505 may be capable of handling low-level tasks, may be capable of receiving messages intended for it and for the microprocessor device 510, and may know whether to respond on its own behalf, to respond on behalf of the microprocessor device 510, or to store and forward messages to the microprocessor device 510.

In this embodiment, the microcontroller device 505 is a low-to-medium speed processor, is capable of power moding, has RAM, and has other IPs to handle timers, interrupts, GPIO, etc. In this embodiment, the microcontroller device 305 does not have internal ROM. The microprocessor device 510 is a higher-speed processor with caching, an FPU and an MMU, has other IPs to handle timers, GPIO, etc., and has multimedia IPs to handle audio, displays, ATAPI, USB, etc. The microprocessor device 510 has a VDD 585 connected to a switched voltage source (“VDD”) controlled by the microcontroller device 505 and a VSS 590 connected to ground.

The microcontroller device 505 includes initial mode setting pins 530. The initial mode setting pins 530 may be user-strapping pins. The microcontroller device 505 may read the pins at power-on and reset to identify protocols, manufacturer information, etc. Based on the pin strapping settings, the microcontroller device 505 may be capable of responding to specific CAN message protocols from specific car manufacturers such as GM, Toyota, Ford, DCX, etc. One set of pin strapping settings may inform the microcontroller device 505 (and thus possibly the microprocessor device 510) that the devices 505 and 510 are installed in a GM device and that GM code must be loaded from ROM/Flash 575 into the internal RAM of the devices 505 and 510. In an embodiment where the microcontroller device 505 has internal ROM, the set of pin strapping settings may inform the microcontroller device 505 to load the GM code from internal ROM to internal RAM. The microcontroller device 505 may include multiple sequencers, one for each standard, such that a particular pin strapping setting indicates the sequencer to be used. The sequencer may be capable of responding to requests based on the particular standard. Being configured, at power-on and reset, the microcontroller device 505 can use proper protocols to reply to incoming CAN messages from a master control unit attempting to identify modules on the vehicle network 540. For example, as the microprocessor device 510 initializes, the microcontroller device 505 may provide a response such as “not-ready.”

In this embodiment, since the microcontroller device 505 does not have internal ROM, the microcontroller device 505 may have a hard-coded sequencer to handle low-level tasks. The hard coded sequencer may be capable of responding to the specific CAN message protocol requests, responding to master control units during power-on/reset, and loading control code from the microprocessor device 510.

Microcontroller device 505 control code, such as GM's GMLAN (OnStar) protocols, Daimler/Chrysler's DCNET protocols, Ford's FNOS protocols, or the like, for handling initial CAN message functions or other independent functions, may be stored in the ROM/Flash 575. When the microprocessor device 510 becomes active, the hard-coded sequencer in the microcontroller device 505 may download (or the microprocessor device 510 may upload) the microcontroller control code via the link 525/530 from the ROM/Flash 575 to internal RAM in the microcontroller device 505. Then, after configuration, the microcontroller device 505 may be capable of responding to additional requests or providing additional information in response to requests. Since ROM/Flash 575 is cheaper than internal ROM, this technique may be more cost effective. Further, since multiple electronic devices may be configured to access a single ROM/Flash 575, only one compliance certificate from the manufacturer (e.g., GM, Ford, etc.) may be needed per group of integrated packages 595. Also, a single version of microcontroller device 505 may be used for all variations of the microprocessor device 510 family. This may reduce time to market. Loading the microcontroller control code into the microcontroller device 505 may be necessary upon initial start-up, after the battery dies, upon detecting a system error, upon a system reset, etc.

Similarly, the microprocessor device 510 may have microprocessor control code stored on the ROM/Flash 575 that configures the microprocessor device 510. A hard-coded sequencer on the microprocessor device 510 or a bootstrap program may cause the microprocessor device 510 to download the microprocessor control code from the ROM/Flash 575. Loading the microprocessor control code into the microprocessor device 510 may be necessary whenever the microprocessor is turned on, reset or possibly awakened from stand-by mode. Alternatively, stand-by mode may provide sufficient power purely to maintain the data in the microprocessor internal RAM, so that reloading is not needed.

Further, the microcontroller device 505, which is always on, may be capable of accepting user interrupts and, in turn, powering the microprocessor device 510 to respond to the interrupts. For example, when a user turns the key half-way on the ignition, the microcontroller device 505 may power on the microprocessor device 510, thus enabling the radio to turn on, the phone extensions to operate, the windows to open, etc.

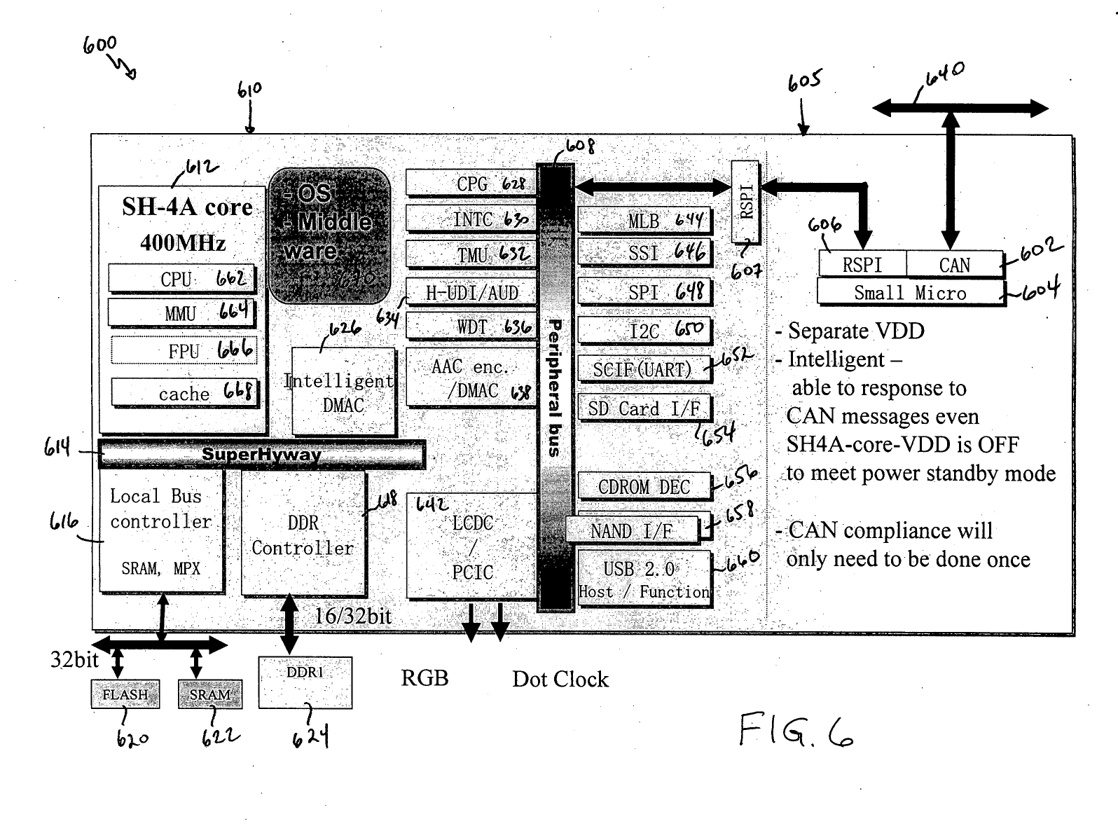

FIG. 6 is a block diagram illustrating an example integrated package 600, in accordance with an embodiment of the present invention. Example integrated package 600 includes microcontroller device portion 605 coupled to a microprocessor device portion 610. The microcontroller device portion 605 is coupled to the CAN vehicle network 640.

The microcontroller device portion 605 includes a CAN IP module 602, a small microprocessor device 604 and an RSPI device 606. The CAN IP module 602 is coupled to and is capable of communicating with the vehicle network 640. The RSPI device 606 is capable of communicating with an RSPI device 607 on the microprocessor device portion 610 (described below).

The microprocessor device portion 610 includes a 400 MHz core 612, with a CPU 662, MMU 664, FPU 666 and caches 668, coupled to a superhighway 614. The microprocessor device portion 610 may also have an intelligent DMA Controller (DMAC) 626, a local bus controller 616 (which may be coupled in turn to a Flash 620 and to SRAM 622), and a DDR controller 618 (which may be coupled in turn to a DDR memory 624), each coupled to the superhighway 614. The microprocessor device portion 610 may also include a clock pulse generator (CPG) 628, an interrupt controller (INTC) 630, a timer unit (TMU) 632, a Hitachi user debugger interface/advanced user debugger (H-UDI/AUD) 634, a watchdog timer (WDT) 636, an advanced audio coding (AAC) encoder/DMAC 638, an LCD controller/PCI controller (LCDC/PCIC) 642, an RSPI device 607 which is coupled to the RSPI device 606 on the microcontroller device portion 605, a main logic board (MLB) 644, a serial sound interface (SSI) 646, a serial peripheral interface (SPI) 646, an inter-integrated circuit bus (I2C) 650, a serial communication interface with FIFO (SCIF/UART) 652, a secure digital (SD) card interface 654, a CDROM decoder 656, NAND interface(s) 658 and a USB 660, each coupled to the peripheral bus 608. The microprocessor device portion 610 may also include an operating system and middleware 670.

The integrated package 600 uses separate VDD to the microcontroller device portion 605 and to the microprocessor device portion 610. The microcontroller device portion 605 is capable of responding to CAN messages, even when the VDD to the core 612 is off or in power standby mode. Accordingly, using this integrated package 600, CAN compliance need only be done once.

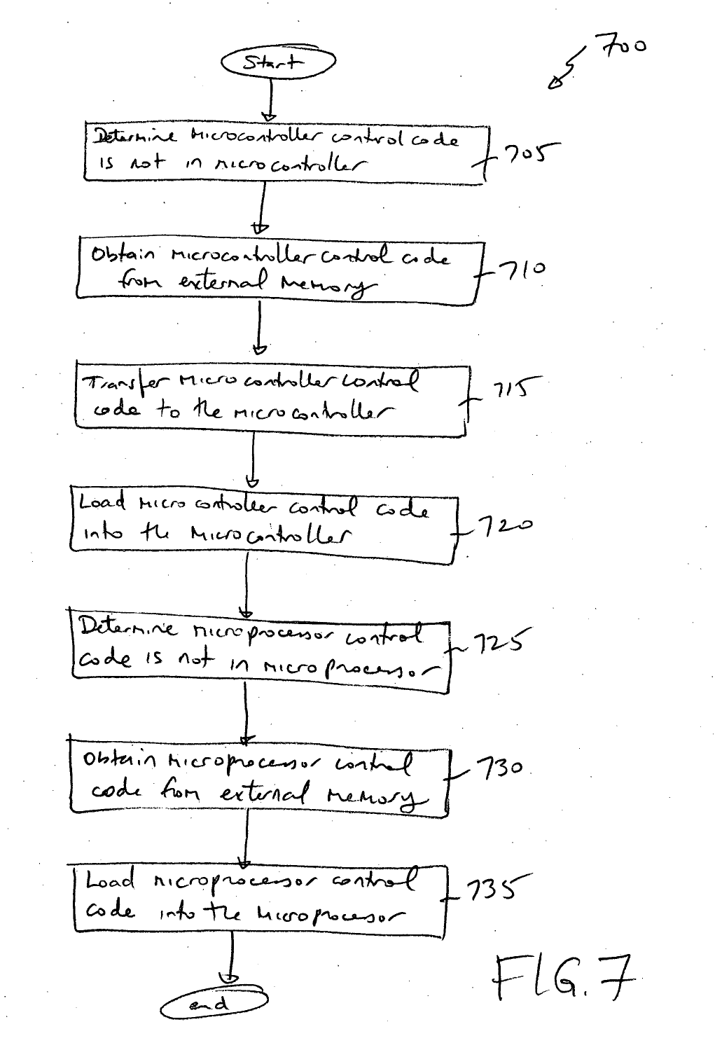

FIG. 7 is a flowchart illustrating a method 700 of loading control code into the microcontroller device 505 and into the microprocessor device 510, in accordance with an embodiment of the present invention. In this embodiment, the method 700 begins with the microcontroller device 505 determining in step 705 that the microcontroller control code is not loaded onto the microcontroller device 505. Alternatively, step 705 can be implemented by the microprocessor device 510 or other device. In step 710, the microprocessor device 510 obtains the microcontroller control code from external memory (whether permanent or temporary), e.g., ROM/Flash 575. Step 710 may be occur in response to a request from the microcontroller device 505 or upon microprocessor device 510 determining it necessary. Step 710 may include reading the initial mode setting pins 530 to determine which microcontroller control code to select from various, e.g., manufacturer-dedicated, microcontroller control code options. The microprocessor device 510 in step 715 transfers the microcontroller control code to the microcontroller device 505. The microcontroller device 505 in step 720 loads the microcontroller control code into internal RAM for execution.

In step 725, the microprocessor device 510 determines that microprocessor control code is not loaded onto the microprocessor device 510. The microprocessor device 510 in step 730 obtains the microprocessor control code from external memory, which is possibly the same external memory as containing the microcontroller control code, e.g., ROM/Flash 575. Step 730 may include reading the initial mode setting pins 530, communicating with the microcontroller device 505 about the initial mode setting pins 530, reading initial mode setting pins (not shown) on the microprocessor device 510, etc. to determine which microprocessor control code to select from various, e.g., manufacturer-dedicated, microprocessor control code options. The microprocessor device 510 in step 735 loads the microprocessor control code into internal RAM for execution. Method 700 then ends.

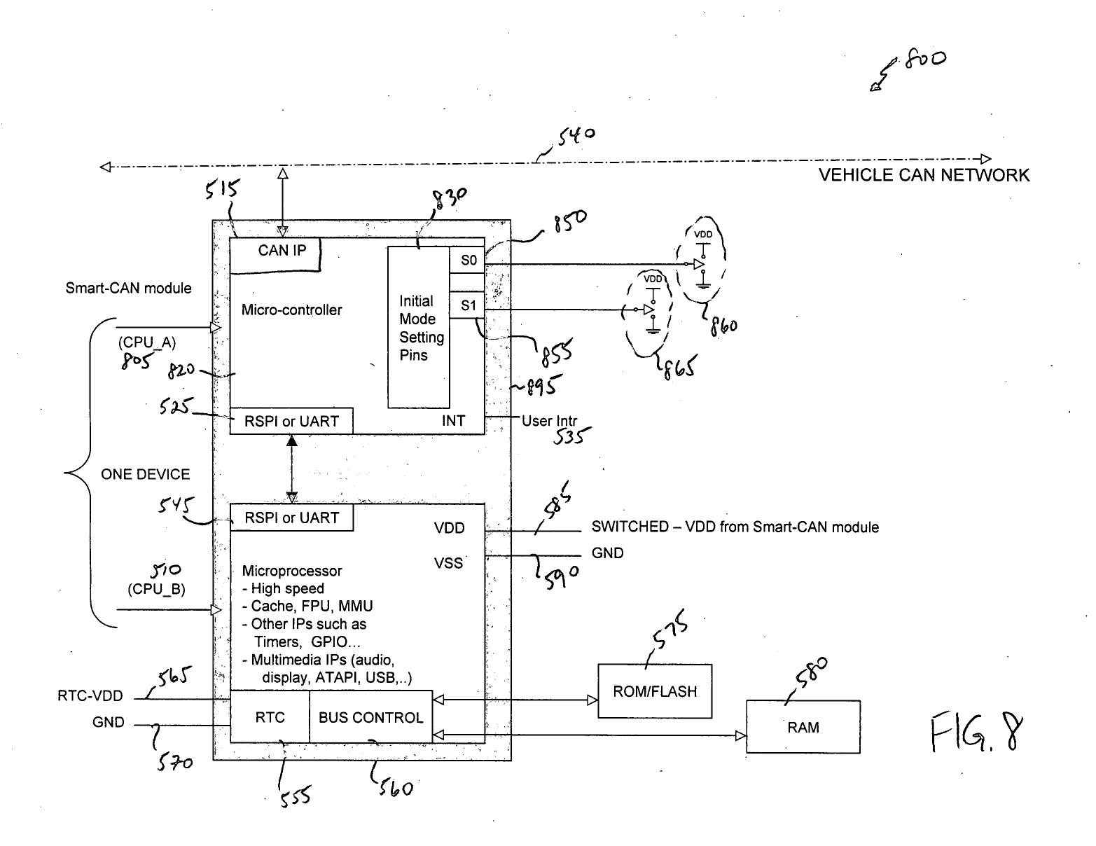

FIG. 8 is a block diagram of vehicle CAN network system 800, in accordance with an embodiment of the present invention. Vehicle CAN network system 800 includes modules and connections similar to those of FIG. 5. Thus, the modules and connections of FIG. 8 are labeled as elements 510, 515, 525, 535, 540, 545, 555, 560, 565, 570, 575, 580, 585, 590, as in FIG. 5. For convenience, a discussion of the elements is not repeated, although the modules and connections need not be identical.

In this embodiment, the microcontroller device 805 includes initial mode setting pins 830, including a first pin “S0” 850 coupled to a first switch 860 and a second pin “S1” 855 coupled to a second switch 865. Since the initial mode setting pins 830 include two pins coupled to two switches, four alternative standards may be managed, e.g., such as the standards from GM, Chrysler, Ford and Toyota. Namely, inputs S0=ground+S=ground results in the microcontroller device 805 being configured to use GM standard protocols, inputs S0=ground+S1=VDD results in the microcontroller device 805 being configured to use Chrysler standard protocols, inputs S0=VDD+S1 ground results in the microcontroller device 805 being configured to use Ford standard protocols, and inputs S0=VDD+S1=VDD results in the microcontroller device 805 being configured to use Toyota standard protocols. As stated above, to effect these alternatives, the microcontroller device 805 may include multiple sequencers, one for each standard, such that a particular pin strapping settings indicates the particular sequencer to be used. At the reception of a vehicle bus message (CAN message), the microcontroller can respond properly to the message even though the fully functional CAN handler has not been loaded. The responding message mostly will be ‘CAN message received by microcontroller with CAN Identification number. Please wait’. Alternatively or additionally, the pin strapping settings 830 may identify code to upload/download from the ROM/Flash 575 to the microcontroller device 805 and/or to the microprocessor device 510. Alternatively or additionally, the pin strapping settings 830 may identify internal ROM in the microcontroller device 805 and/or in the microprocessor device 510 to use. Other alternatives are also possible.

It should be appreciated that the term “always active,” “always on,” etc. should not mean that the circuit is on during events like power failures, system errors, etc.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Although the embodiments herein are described generally with reference to the CAN-based vehicle network, one skilled in the art will recognize that embodiments may be practiced using other vehicle networks such as FlexRay or IEBus. The various embodiments set forth herein may be implemented utilizing hardware, software, or any desired combination thereof. For that matter, any type of logic may be utilized which is capable of implementing the various functionality set forth herein. Components may be implemented using a programmed general-purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A system comprising:
an integrated package including
a microcontroller having a vehicle bus controller for communicating directly with a vehicle bus, the microcontroller being always active; and
a microprocessor having a communication module for communicating with the microcontroller, and not having a vehicle bus controller for communicating directly with the vehicle bus.

2. The system of claim 1, wherein the vehicle bus controller is a CAN controller.

3. The system of claim 1, further comprising a power switch circuit for enabling the microcontroller to control power to the microprocessor.

4. The system of claim 3, wherein the power switch circuit also controls the state of the microprocessor.

5. The system of claim 1, wherein the microcontroller and the microprocessor intercommunicate via a dedicated channel.

6. A system comprising:
an integrated package including
a microcontroller having a vehicle bus controller for communicating directly with a vehicle bus, having internal RAM, and having a hard-coded sequencer for enabling the microcontroller to load microcontroller control code into the internal RAM, the microcontroller being always active; and
a microprocessor having a communications module for communicating with the microcontroller, and having access to microcontroller control code for the microcontroller, the microprocessor being configured to forward the microcontroller control code to the microcontroller, the microprocessor being faster than the microcontroller.

7. The system of claim 6, wherein the vehicle bus controller is a CAN controller.

8. The system of claim 6, further comprising a power switch circuit for enabling the microcontroller to control power to the microprocessor.

9. The system of claim 8, wherein the power switch circuit also controls the state of the microprocessor.

10. The system of claim 6, wherein the microcontroller and the microprocessor intercommunicate via a dedicated channel.

11. A method, comprising:
determining that microcontroller control code is not loaded on a microcontroller, the microcontroller being connectable to a vehicle network;
obtaining microcontroller control code from first external memory by a microprocessor, the microprocessor being faster than the microcontroller and being communicatively coupled to the microcontroller, the microcontroller and microprocessor being integrated in the same package;
transferring the microcontroller control code from the first external memory to the microcontroller; and
loading the microcontroller control code into internal RAM on the microcontroller.

12. The method of claim 11, further comprising determining that microprocessor control code is not loaded into the microprocessor.

13. The method of claim 12, further comprising obtaining microprocessor control code from second external memory.

14. The method of claim 13, wherein the first external memory and second external memory are part of the same device.

15. The method of claim 13, further comprising loading the microprocessor control code into internal RAM on the microprocessor device.

16. The method of claim 11, wherein the microcontroller control code is compliant with a vehicle bus standard.

17. The method of claim 11, wherein the first external memory is also coupled to another package including another microcontroller and microprocessor pair.

18. The method of claim 11, further comprising using pin strapping settings to select the microcontroller control code from a set of various microcontroller control code options.
